(19) United States
(12) Patent Application Publication
(10) Pub. No.: US 2026/0105155 A1
(43) Pub. Date: Apr. 16, 2026

(54) VULNERABILITY REMEDIATION FOR CLOUD MACHINES

(71) Applicant: SAP SE, Walldorf (DE)

(72) Inventor: M N Sudhir K, Bangalore (IN)

(21) Appl. No.: 18/912,847

(22) Filed: Oct. 11, 2024

(51) Int. Cl. G06F 21/57; G06F 21/56

(52) U.S. Cl. CPC G06F 21/577; G06F 21/565

(57) ABSTRACT

Various examples are directed to systems and methods for maintaining a plurality of cloud-based machines. A processor may access vulnerability data describing a software application executed by a portion of the plurality of cloud-based machines and a remedial change to the software application. The processor may also access a pre-remediation version of a first file of the software application from a first cloud-based machine of the portion of the plurality of cloud-based machines. The processor may generate a cryptographic hash of the pre-remediation version of the first file. Using the vulnerability data, the processor may execute a trained computerized model to generate a correction script, the correction script being executable to implement the remedial change to the software application. The processor may cause the correction script to execute at the portion of the plurality of cloud-based machines to implement the remedial change to the software application.

### BACKGROUND

From time to time, software application vulnerabilities are discovered. A software application vulnerability is a weakness in the software application that can be exploited by a malicious user to compromise the software application. For example, a vulnerability may allow a malicious actor to affect the operation of the software application, to access potentially confidential data of the software application, and/or the like.

### BRIEF DESCRIPTION OF DRAWINGS

The present disclosure is illustrated by way of example and not limitation in the following figures.

FIG. 1 is a diagram showing one example of an environment including a cloud environment and a vulnerability management system.

FIG. 2 is a diagram showing one example of a workflow that may be executed, for example, in the environment of FIG. 1 to correct a software application vulnerability.

FIG. 3 is a flowchart showing one example of a process flow that may be executed in the environment of FIG. 1 to detect and correct a software application vulnerability.

FIG. 4 is a flowchart showing one example of a process flow that may be executed in the environment of FIG. 1 to verify a correction script generated by the trained computerized model.

FIG. 5 is a flowchart showing one example of a process flow that may be executed in the environment of FIG. 1 to identify machines suffering from a vulnerability using a previously generated pre-remediation hash of one or more files associated with the vulnerability.

FIG. 6 is a block diagram showing one example of an architecture for a computing device.

FIG. 7 is a block diagram of a machine in the example form of a computer system within which instructions may be executed for causing the machine to perform any one or more of the methodologies discussed herein.

### DETAILED DESCRIPTION

Software application vulnerabilities can often be corrected by making changes to the software application and/or other software applications executing at the same virtual or hardware machine. In some examples, correcting a software vulnerability can include modifying a setting of the software application such as, for example, a state of a port, and/or the like. Also, in some examples, correcting a software vulnerability may include changing the version of the software application and/or a component file of the software application.

Corrections to address software application vulnerabilities can be performed manually. For example, an administrative user may receive an indication of the vulnerability and manually make indicated remedial changes to the software application. Although this arrangement can work well for smaller enterprises and smaller systems, it may not scale. Consider an example in which an enterprise manages multiple software applications executing at a large computing system network. Manually upgrading each virtual and/or hardware machine in the network may be cost and time prohibitive.

In some examples, these challenges may be addressed by utilizing correction scripts. An administrative user may receive an indication of a software vulnerability. The indication of the software vulnerability may include, for example, a remedial change to correct the software application vulnerability. The administrative user may write a script to implement the remedial change. The script is executable code that can be executed at one or more machines in order to implement the remedial change. For example, the script may be written in JavaScript or another suitable interpreted language. In some examples, the script is written in a compiled language and provided to machines as executable object code.

Although the use of scripts may facilitate limited scaling, it may still consume considerable resources. For example, when an enterprise is responsible for the execution of a large number of machines at a public and/or private cloud environment, administrative users may be responsible for coding and managing the execution of a very large number of scripts.

Various examples described herein address these and other challenges by implementing automatic software application vulnerability remediation with a trained computerized model and signature-based verification. For example, a vulnerability management system may manage a large number of virtual and/or hardware machines executing across one or more cloud environments implemented by one or more cloud hyperscalers. The vulnerability management system may be programmed to receive vulnerability data describing one or more software application vulnerabilities identified for software applications executing across the one or more cloud environments. The vulnerability management system may execute a trained computerized model, such as a large language model. The trained computerized model may receive the vulnerability data as an input and generate an output including a correction script. The correction script generated by the trained computerized model may be executed at one or more of the managed machines to correct the identified software application vulnerability.

In some examples, hash or signature data may be used to verify the correction of software application vulnerabilities. For example, because the scripts are generated by a trained computerized model, and not by human users, it may be desirable to verify that the scripts executed as expected to correct the identified software application vulnerability. To verify, the vulnerability management system may generate a cryptographic hash of one or more files associated with the software application. In some examples, the cryptographic hash may be taken before execution of the correction script (e.g., a pre-remediation hash) and after execution of the correction script (e.g., a post-remediation hash). The pre-remediation hash may be compared to the post-remediation hash. Based on the comparison, the vulnerability management system may determine whether the attempted correction of the vulnerability was successful. If the pre-remediation hash of the file and the post-remediation hash of the file do not match, it may indicate that the correction script successfully remediated the software application vulnerability. If the pre-remediation hash of the file and the post-remediation hash of the file do match, an administrative user may be alerted to correct the vulnerability.

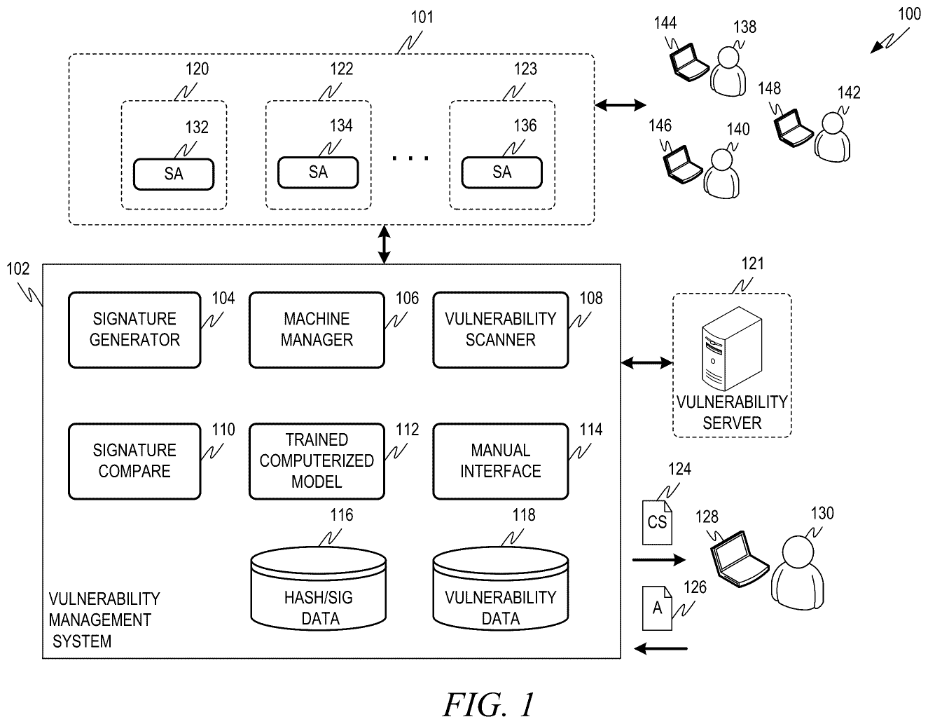

FIG. 1 is a diagram showing one example of an environment 100 including a cloud environment 101 and a vulnerability management system 102. The cloud environment 101 comprises a plurality of cloud-based machines 120, 122, 123. The vulnerability management system 102 is programmed to manage and remedy vulnerabilities at software applications 132, 134, 136 executing at the respective machines 120, 122, 123 of the cloud environment 101.

Users 138, 140, 142 may access software applications 132, 134, 136 at cloud environment 101. For example, the respective machines 120, 122, 123 may execute software applications 132, 134, 136 in the cloud environment 101. Users 138, 140, 142 may access the cloud environment 101 to utilize the software applications 132, 134, 136. Users 138, 140, 142 may access the cloud environment 101 utilizing user computing devices 144, 146, 148. The user computing devices may be any suitable computing device such as, for example, a mobile computing device, a laptop computing device, a desktop computing device, and the like.

The applications 132, 134, 136 may be any suitable applications executed for any suitable purpose. In some examples, one or more of the applications 132, 134, 136 may be or include an analytics software solution such as the SAP® Analytics Cloud application available from SAP SE of Walldorf, Germany, a human capital management software solution such as SAP SuccessFactors®, also available from SAP SE of Walldorf, Germany, along with resources for project management provided by a project management software solution such as SAP Portfolio and Project Management (PaPM), also available from SAP SE of Walldorf, Germany. Also, in some examples, one or more of the applications 132, 134, 136 may be or include a database management application such as, for example, the HANA system, also available from SAP SE of Walldorf, Germany. Also, in some examples, one or more of the software applications 132, 134, 136 may be or include infrastructure and/or support applications such as, for example, operating systems, framework applications for Java and other interpreted languages such as, for example, Spring Boot, Apache Tomcat, and/or the like.

Machines 120, 122, 123 may be hardware machines and/or virtual machines. Hardware machines may include servers or other computing hardware managed by the cloud hyperscaler or hyperscalers implementing the cloud environment 101. A virtual machine executes on a hardware machine and provides a software environment for the execution of applications, such as the software applications 132, 134, 136. A virtual machine may execute on a hardware machine managed by the cloud hyperscaler or hyperscalers implementing the cloud environment 101.

The cloud environment 101 may be implemented using one or more cloud hyperscalers. A cloud hyperscaler is a service that maintains one or more data centers comprising various computing hardware. Examples of currently available cloud hyperscaler services include AWS from Amazon. com, Inc., Google Cloud from Google LLC., Azure from Microsoft, Inc., and Alibaba Cloud from Alibaba Group Holding Limited, among others.

Client enterprises (e.g., enterprises that are clients of the one or more cloud hyperscalers) may use hardware resources at the cloud hyperscaler data centers to execute applications and/or perform data storage that might otherwise have been performed using an on-premises computing system. In this way, the client enterprises utilize the hardware infrastructure resources of the cloud hyperscaler in place of an on-premises or other enterprise-implemented computing system.

Cloud hyperscalers may use a shared responsibility model for implementing cloud environments where the cloud hyperscaler is responsible for configuring and maintaining the physical hardware at its data centers, while the client enterprise is responsible for the configuration and management of the virtual compute elements, storage elements, and/or network elements making up the cloud environments. A client enterprise, therefore, may utilize the cloud hyperscaler to implement one or more public or private cloud environments, such as the cloud environment 101. The client enterprise may provide software applications executing at the cloud hyperscaler hardware.

The cloud environment 101 may be a public cloud environment and/or a private cloud environment. In a private cloud environment, an enterprise associated with the users 138, 140, 142 may provide executables and other files to implement the software applications 132, 134, 136. In a public cloud environment, the software applications 132, 134, 136 may be provided as one of a number of tenancies implemented by the hyperscaler. A cloud service provider enterprise may provide one or more executables or other components to implement the applications 132, 134, 136 at the public cloud environment. An enterprise using the applications 132, 134, 136 may hold one or more tenancies, allowing users 13A, 140, 142 associated with the enterprise to access one or more instances of the applications 132, 134, 136 at the public cloud environment.

The vulnerability management system 102 may be implemented by an enterprise with responsibility for maintaining the software applications 132, 134, 136. For example, in the context of a public cloud environment, the vulnerability management system 102 may be implemented by a cloud service provider enterprise. In examples where the cloud environment 101 is a private cloud environment, the vulnerability management system 102 may be implemented by an enterprise associated with the users 138, 140, 142 such as, for example, an employer of the users 138, 140, 142. It will be appreciated, however, that other arrangements may also be used. For example, the vulnerability management system 102 may be implemented by a third-party service enterprise or in another suitable arrangement.

The vulnerability management system 102 may be implemented in an on-premises environment or in a cloud environment. In some examples, the vulnerability management system 102 is implemented in the same cloud environment 101 as the machines 120, 122, 123.

The vulnerability management system 102 may be in communication with a vulnerability server 121 and an administrative user 130. The vulnerability management system 102 may be in communication with the vulnerability server 121 via any suitable network connection and may be in communication with the administrative user 130 via a user computing device 128.

The vulnerability management system 102 may comprise various components and subsystems including, a machine manager system 106, a vulnerability scanner system 108, a trained computerized model 112, a signature generator system 104, a signature compare system 110 and a manual interface system 114. The vulnerability management system 102 may also store various data at one or more data stores. The example of FIG. 1 shows a hash/signature data store 116 and a vulnerability data store 118. The data stores 116, 118 may be or include any suitable data storage hardware and/or software. Also, although two different data stores 116, 118 are shown in FIG. 1, it will be appreciated that hash/signature data and vulnerability data may be stored in a single data store and/or stored across more than two data stores.

The vulnerability management system 102 may be programmed to detect vulnerabilities at the software applications 132, 134, 136 and utilize the computerized model 112 to generate correction scripts. The vulnerability management system 102 may cause the correction scripts to execute at the machines 120, 122, 123 to remediate detected vulnerabilities.

The vulnerability scanner system 108 may scan the cloud environment 101 to identify machines 120, 122, 123 executing software applications 132, 134, 136 that are subject to a vulnerability. In some examples, the vulnerability scanner system 108 may access the vulnerability server 121 to receive vulnerability data. The vulnerability server 121 may be any suitable data source comprising data describing software application vulnerabilities such as, for example, the National Vulnerability Database provided by the National Institute of Standards and Technology (NIST) of the United States Department of Commerce. In other examples, vulnerability scanner system 108 may use a comparison of hash values to detect a vulnerability as is described further below.

The vulnerability data may describe a software application or applications and an associated vulnerability. In some examples, the vulnerability data may also describe a remedial change to the software application to fix or remedy the vulnerability. This may include, for example, upgrading the software application to a different version, changing a configuration of the software application, closing a port used by the software application 132, 134, 136, and/or the like. The vulnerability scanner system 108 may scan the cloud environment 101 to identify machines 120, 122, 123 that are executing the software application described by the vulnerability data. In some examples, received vulnerability data may be stored at the vulnerability data store 118.

If the vulnerability scanner system 108 determines that one or more of the software applications 132, 134, 136 possess the indicated vulnerability, the trained computerized model 112 may be used to generate a correction script. The correction script may be executable code that is executable at relevant machines 120, 122, 123 to correct or remediate the vulnerability. In some examples, the correction script is JavaScript or another similar interpreted language. In other examples, the correction script may be generated in a compiled language and may include object code that is executable at relevant machines 120, 122, 123. For example, the trained computerized model 112 may generate source code. The vulnerability management system 102 may compile the source code to generate the object code. The object code may be executed at the respective machines 120, 122, 123.

The trained computerized model 112 may be any suitable computerized model that is trained to receive vulnerability data as input and generate correction scripts as output. In some examples, the trained computerized model 112 also receives additional inputs such as, for example, details of the machines 120, 122, 123, the software applications 132, 134, 136, and/or the like. In some examples, the trained computerized model 112 includes executable code that is executed at the vulnerability management system 102. In some examples, the trained computerized model 112 is executed outside the vulnerability management system 102 such as, for example, at a remote server or a server system.

In some examples, the trained computerized model 112 is a large language model (LLM). An LLM is a computerized model that is trained to recognize and predict patterns in language or other groupings of alphanumeric characters. An LLM may be structured, for example, using a transformer structure. Example LLM's that may be used include the ChatGPT LLM available from OpenAI, the Large Language Model Meta AI (Llama) available from MetaAI, the Gemini LLM available from Google LLC, and/or the like.

A machine manager system 106 may manage the execution of the correction script at the relevant machines 120, 122, 123. For example, the machine manager system 106 may provide the correction script to machines 120, 122, 123 executing software applications 132, 134, 136 that are described by the vulnerability data. Execution of the correction scripts may remedy the identified vulnerability at the relevant machines 120, 122, 123.

In some examples, the vulnerability management system 102 is programmed to consider software application signatures or hashes. For example, because the correction scripts are generated by a trained computerized model, and may not be generated by human users, it may be desirable to verify that the correction script executed correctly and succeeded in resolving the vulnerability indicated by the vulnerability data.

In some examples, after identifying a vulnerability at a particular machine 120, 122, 123 and before executing a correction code, a signature generator system 104 may apply a cryptographic hash function to at least one file of the software application 132, 134, 136 having the identified vulnerability. In some examples, the cryptographic hash function is applied to multiple files of a software application 132, 134, 136 up to, for example, all of the files associated with the software application 132, 134, 136. The result is a cryptographic hash of a pre-remediation version of the file or files. In some examples, the cryptographic hash of pre-remediation versions of the file or files is stored at the hash/signature data store 116.

After the correction script is executed, the signature generator system 104 generates a cryptographic hash of a post-remediation version of the file or files. A signature compare system 110 compares the pre-remediation hash of the file or files to the post-remediation hash of the file or files. Based on the comparing, the vulnerability management system 102 may determine whether the attempted correction of the vulnerability was successful. If the two hashes are the same, it may indicate that the underlying software application 132, 134, 136 is the same and/or is in the same configuration as it was prior to execution of the correction script. This may indicate that the correction script has failed to correct the vulnerability. If the pre-remediation and post-remediation hashes do not match, it may indicate that the correction script did successfully modify the software application 132, 134, 136. This may, in turn, indicate that the vulnerability has been corrected.

In some examples, cases where the correction script has failed to correct the vulnerability may be provided to the administrative user 130. In response, the administrative user 130 may manually correct the vulnerability. For example, the administrative user 130 may interact with the vulnerability management system 102 via a manual interface system 114. In some examples, the vulnerability management system 102 sends the administrative user 130 a message including a copy of the correction script that was executed at the machine or machines 120, 122, 123. In some examples, the administrative user 130 may also be provided with a copy of the accessed vulnerability data. The administrative user 130 may modify the correction script and/or generate a replacement correction script that may be subsequently executed at the machine or machines 120, 122, 123.

In some examples, correction scripts generated by the trained computerized model 112 are provided to one or more administrative users, such as the administrative user 130. The vulnerability management system 102 may send the administrative user 130 a message 124 comprising a correction script generated by the trained computerized model 112. The administrative user 130 may review the correction script to verify its correctness. If the administrative user 130 fails to provide an indication that the correction script is correct, the correction script may not be executed. For example, the trained computerized model 112 may be used to generate an additional correction script and/or the administrative user 130 may be prompted to manually create a correction script for the indicated vulnerability. On the other hand, if the administrative user 130 determines that the correction script generated by the trained computerized model 112 is acceptable, the administrative user 130 may provide an approval message 126 to the vulnerability management system 102. Upon receiving the approval message 126, the vulnerability management system 102 may cause the machine manager system 106 to prompt execution of the correction script at the relevant machine or machines 120, 122, 123.

In some examples, stored signature data at the hash/signature data store 116 may be used as a baseline to identify machines 120, 122, 123 that are subject to a known vulnerability. For example, the machine manager system 106 may access a file or files from the software applications 132, 134, 136 corresponding to a particular hash value at the hash/signature data store 116. The signature generator system 104 may be used to generate a hash of the accessed file or files. The hash of the accessed file or files may be compared to the stored hash from the hash/signature data store 116. If the two hashes match, it may indicate that the software application 132, 134, 136 has the indicated vulnerability.

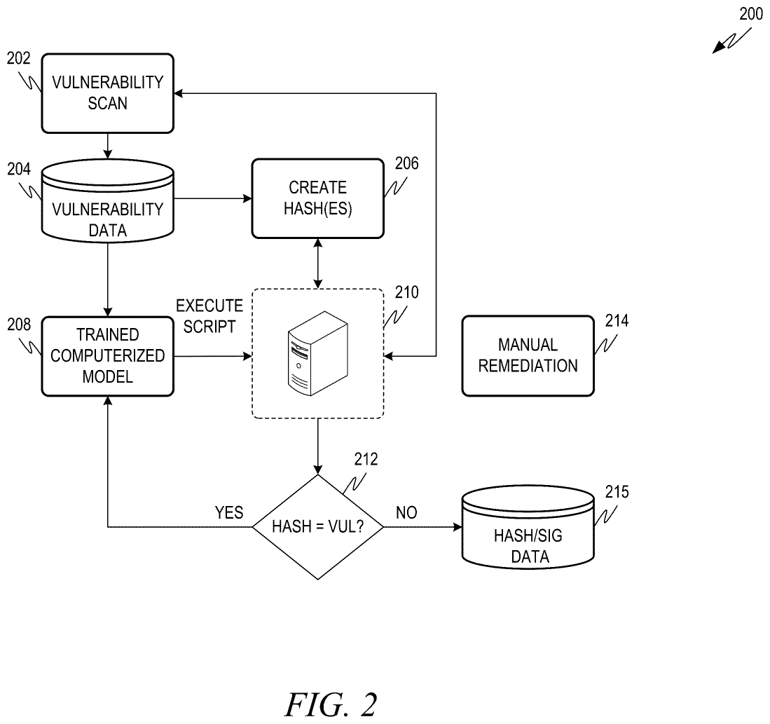

FIG. 2 is a diagram showing one example of a workflow 200 that may be executed, for example, in the environment 100 of FIG. 1 to correct a software application vulnerability. At operation 202, the vulnerability management system 102 may perform a vulnerability scan on a software application on machine 210. This may include accessing vulnerability data 204, which may be accessed from a vulnerability server 121.. At operation 206, the vulnerability management system 102 may create one or more cryptographic hashes of one or more files from a machine 210. The machine 210 may be, for example, a machine that executes the software application indicated by the vulnerability data. The hash generated at operation 206 may, at operation 212, be compared to a stored hash of the one or more files associated with the vulnerability. The stored hash may be retrieved from hash/signature data store 215. If the generated hash meets the stored hash at operation 212, then the trained computerized model 208 may be used to generate the correction script.

If a software application is resident on machine 210 that includes a vulnerability, the vulnerability management system 102 may execute a trained computerized model 208 to generate a correction script to address the vulnerability indicated by the vulnerability data 204. The correction script may be executed at a machine 210 that updates or otherwise removes the vulnerability or vulnerabilities from the software application.

FIG. 2 also shows a manual remediation operation 214. At the manual remediation operation 214, an administrative user 130 may address a correction script that failed to correct a vulnerability. For example, as described herein, the vulnerability management system 102 may provide the correction script and, optionally, associated vulnerability data to the administrative user 130. The administrative user 130 may provide an updated version of the correction script and/or a new version of the correction script. The updated version of the correction script or new correction script may be executed at the portion of the machines 120, 122, 123.

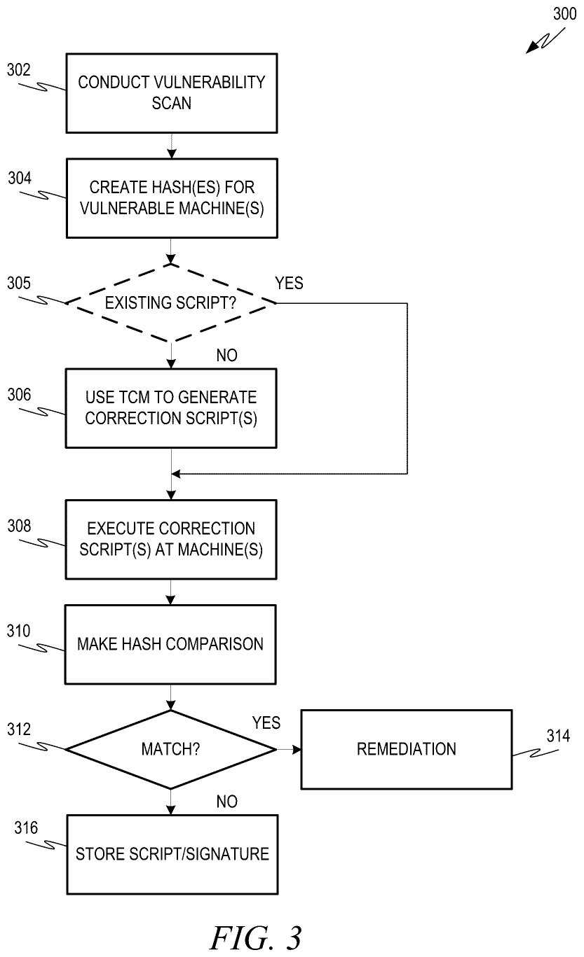

FIG. 3 is a flowchart showing one example of a process flow 300 that may be executed in the environment 100 of FIG. 1 to detect and correct a software application vulnerability. At operation 302, the vulnerability management system 102 may conduct a vulnerability scan. This may include, for example, accessing vulnerability data from the vulnerability server 121 and determining which machine or machines 120, 122, 123 execute a software application 132, 134, 136 described by the vulnerability data. The result of the vulnerability scan may include an indication of a portion of the machines 120, 122, 123 that execute a software application 132, 134, 136 subject to the software application vulnerability. In some examples, the portion of the machines 120, 122, 123 at the cloud environment 101 that execute the software application 132, 134, 136 having the vulnerability may include all of the machines 120, 122, 123 at the cloud environment 101.

At operation 304, the vulnerability management system 102 may create cryptographic hashes for machines 120, 122, 123 included in the portion of machines at the cloud environment 101 that potentially have the vulnerability. At optional operation 305, the vulnerability management system 102 may determine if there is an existing correction script for the vulnerability indicated by the vulnerability data. For example, if the vulnerability has already been corrected at one or more machines (e.g., 120) then a correction script may already have been generated and stored for potential vulnerability correction on other machines (e.g., 122, 123).

If there is no existing correction script (or if the operation 305 is omitted), the vulnerability management system 102 may, at operation 306, use the trained computerized model 112 to generate a correction script. At operation 308, the vulnerability management system 102 may execute the correction script at the portion of the machines 120, 122, 123 at the cloud environment 101 that have the vulnerability.

After executing the correction script at the portion of the machines 120, 122, 123, the vulnerability management system 102 may perform a hash comparison at operation 310. This may include generating a post-remediation cryptographic hash of the one or more files at each of the machines 120, 122, 123 where the correction script was executed. The post-remediation hash can be compared to the pre-remediation hashes for the vulnerable machines generated at operation 304. If the pre-remediation hash for a machine matches the post-remediation hash, it may provide an indication that the vulnerability has not been corrected at that machine. The vulnerability management system 102 may execute additional remediation at operation 314. This may include, for example, referring the matter to an administrative user 130. If the pre-remediation hash for a machine does not match the post-remediation hash for that machine, it may provide an indication that the vulnerability has been corrected at that machine. Accordingly, the vulnerability management system 102 may store the generated correction script and the generated pre-remediation and/or post-remediation hash at operation 316.

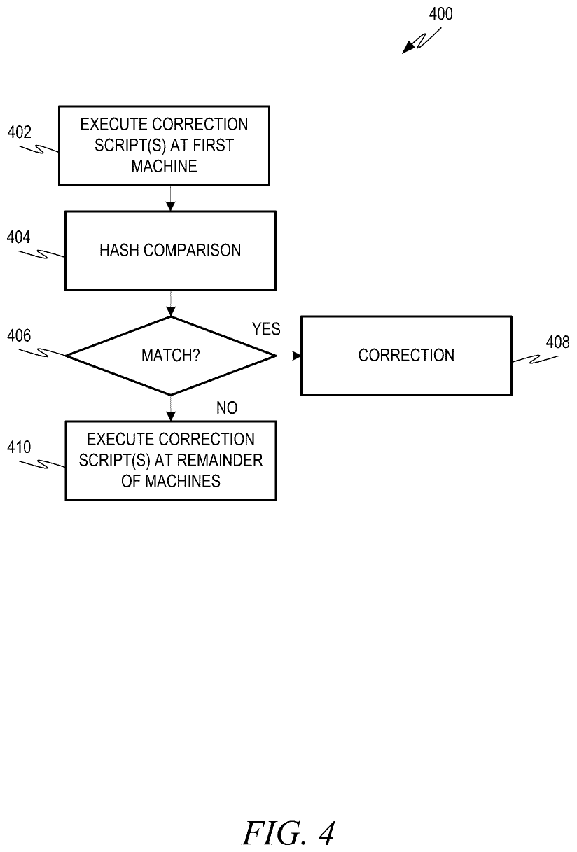

FIG. 4 is a flowchart showing one example of a process flow 400 that may be executed in the environment 100 to verify a correction script generated by the trained computerized model 112. For example, the process flow 400 may be executed when multiple machines 120, 122, 123 suffer from an indicated vulnerability. In this example, the correction script generated by the trained computerized model 112 is first executed at one of the machines. If the execution is successful at the first machine, then the correction script is executed at other machines suffering from the same vulnerability. Prior to executing the correction script at the first machine, the vulnerability management system 102 may have generated a pre-remediation hash of a file or files at the first machine, for example, as described herein with respect to operation 304.

At operation 402, the vulnerability management system may execute the correction script at a first machine. At operation 404, the vulnerability management system 102 may perform a hash comparison. This may include generating a post-remediation hash of the file or files at the first machine that were considered in the pre-remediation hash. If, at operation 406, the pre-remediation and post-remediation hashes match one another, it may indicate that the correction script failed to remedy the vulnerability.

Accordingly, the vulnerability management system 102 may correct the correction script at operation 408. This may involve using the trained computerized model 112 to generate an additional correction script and/or requesting that the administrative user 130 correct the correction script and/or generate an additional correction script manually. If, at operation 406, the pre-remediation and post-remediation hashes do not match one another, it may indicate that the correction script successfully remedied the vulnerability at the machine. Accordingly, the vulnerability management system 102 may, at operation 410, execute the correction script at the remainder of the machines suffering from the same vulnerability.

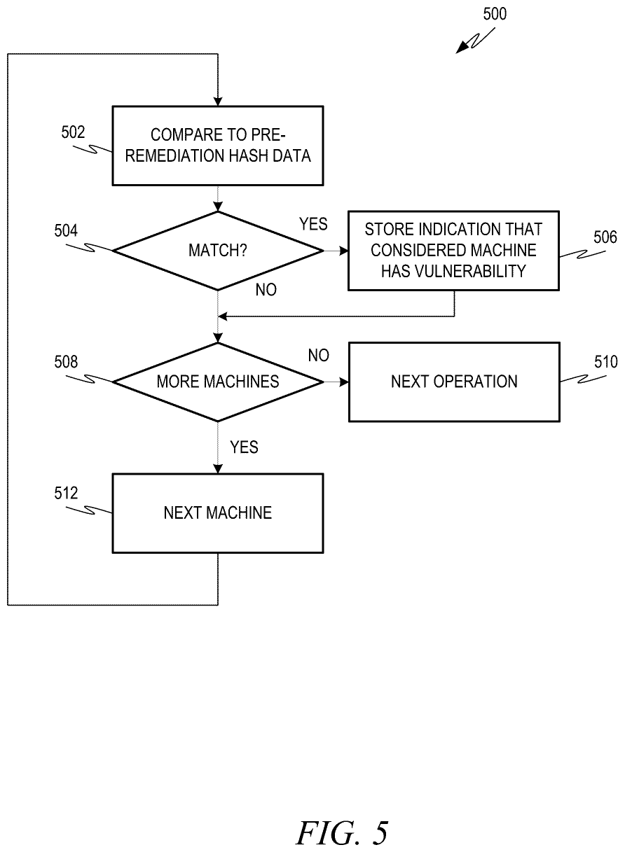

FIG. 5 is a flowchart showing one example of a process flow 500 that may be executed in the environment 100 to identify machines 120, 122, 123 suffering from a vulnerability using a previously generated pre-remediation hash of one or more files associated with the vulnerability. In other words, if one machine (e.g. 120) has been identified as having a software application with a vulnerability, the pre-mediation hash of that application on that machine may be compared against other generated hashes for the software applications on other machines (e.g., 122, 123).

At operation 502, the vulnerability management system 102 may compare a hash for a considered machine to pre-remediation hash data. This may include, for example, generating a comparison hash of the one or more files at the considered machine corresponding to the one or more files described by the pre-remediation hash. If the comparison hash matches the pre-remediation hash at operation 504, then the vulnerability management system 102 may, at operation 506, store an indication that the considered machine has the vulnerability.

If the comparison hash does not match the pre-remediation hash at operation 504, or after storing the indication that the considered machine has the vulnerability at operation 506, the vulnerability management system 102 may determine if there are any additional machines to consider. If there are additional machines to consider, the vulnerability management system 102 may move to the next machine at operation 512 and return to operation 502 to consider the next machine. When there are no more machines to consider at operation 508, the vulnerability management system 102 may move to a next operation at operation 510. A next operation may include, for example, generating a correction script and/or executing the correction script at the machines determined to include the vulnerability.

In view of the disclosure above, various examples are set forth below. It should be noted that one or more features of an example, taken in isolation or combination, should be considered within the disclosure of this application.

### EXAMPLES

Example 1 is a system for maintaining a plurality of cloud-based machines, the system comprising: at least one processor programmed to perform operations comprising: accessing vulnerability data, the vulnerability data describing a software application executed by a portion of the plurality of cloud-based machines and a remedial change to the software application; accessing a pre-remediation version of a first file of the software application from a first cloud-based machine of the portion of the plurality of cloud-based machines; generating a cryptographic hash of the pre-remediation version of the first file; using the vulnerability data, executing a trained computerized model to generate a correction script, the correction script being executable to implement the remedial change to the software application; and executing the correction script at the portion of the plurality of cloud-based machines to implement the remedial change to the software application.

In Example 2, the subject matter of Example 1 optionally includes the operations further comprising: after executing the correction script at the first cloud-based machine, accessing a post-remediation version of the first file from the first cloud-based machine; generating a cryptographic hash of the post-remediation version of the first file; comparing the cryptographic hash of the post-remediation version of the first file to the cryptographic hash of the pre-remediation version of the first file; based on the comparing, determining that the post-remediation version of the first file is different than the pre-remediation version of the first file; and after determining that the post-remediation version of the first file is different than the pre-remediation version of the first file, executing the correction script at a remainder of the portion of the plurality of cloud-based machines.

In Example 3, the subject matter of any one or more of Examples 1-2 optionally include the operations further comprising scanning the plurality of cloud-based machines to identify the portion of the plurality of cloud-based machines executing the software application.

In Example 4, the subject matter of Example 3 optionally includes the scanning comprising comparing the cryptographic hash of the pre-remediation version of the first file to a hash of a current version of the first file at a second cloud-based machine of the plurality of cloud-based machines.

In Example 5, the subject matter of any one or more of Examples 1-4 optionally include the operations further comprising: accessing second vulnerability data, the second vulnerability data describing a second software application executed by a second portion of the plurality of cloud-based machines and a remedial change to the second software application; determining that an existing correction script is executable to implement the remedial change to the second software application; and executing the existing correction script at the second portion of the plurality of cloud-based machines to implement the remedial change to the second software application.

In Example 6, the subject matter of any one or more of Examples 1-5 optionally include the remedial change comprising replacing the pre-remediation version of the first file with a post-remediation version of the first file.

In Example 7, the subject matter of any one or more of Examples 1-6 optionally include the remedial change comprising closing a port at the portion of the plurality of cloud-based machines.

In Example 8, the subject matter of any one or more of Examples 1-7 optionally include the operations further comprising, before executing the correction script at the portion of the plurality of cloud-based machines: sending a message indicating the correction script to an administrative user; and receiving from the administrative user and approval of the correction script.

Example 9 is a method for maintaining a plurality of cloud-based machines, the method comprising: accessing vulnerability data, the vulnerability data describing a software application executed by a portion of the plurality of cloud-based machines and a remedial change to the software application; accessing a pre-remediation version of a first file of the software application from a first cloud-based machine of the portion of the plurality of cloud-based machines; generating a cryptographic hash of the pre-remediation version of the first file; using the vulnerability data, executing a trained computerized model to generate a correction script, the correction script being executable to implement the remedial change to the software application; and executing the correction script at the portion of the plurality of cloud-based machines to implement the remedial change to the software application.

In Example 10, the subject matter of Example 9 optionally includes after executing the correction script at the first cloud-based machine, accessing a post-remediation version of the first file from the first cloud-based machine; generating a cryptographic hash of the post-remediation version of the first file; comparing the cryptographic hash of the post-remediation version of the first file to the cryptographic hash of the pre-remediation version of the first file; based on the comparing, determining that the post-remediation version of the first file is different than the pre-remediation version of the first file; and after determining that the post-remediation version of the first file is different than the pre-remediation version of the first file, executing the correction script at a remainder of the portion of the plurality of cloud-based machines.

In Example 11, the subject matter of any one or more of Examples 9-10 optionally include scanning the plurality of cloud-based machines to identify the portion of the plurality of cloud-based machines executing the software application.

In Example 12, the subject matter of Example 11 optionally includes the scanning comprising comparing the cryptographic hash of the pre-remediation version of the first file to a hash of a current version of the first file at a second cloud-based machine of the plurality of cloud-based machines.

In Example 13, the subject matter of any one or more of Examples 9-12 optionally include accessing second vulnerability data, the second vulnerability data describing a second software application executed by a second portion of the plurality of cloud-based machines and a remedial change to the second software application; determining that an existing correction script is executable to implement the remedial change to the second software application; and executing the existing correction script at the second portion of the plurality of cloud-based machines to implement the remedial change to the second software application.

In Example 14, the subject matter of any one or more of Examples 9-13 optionally include the remedial change comprising replacing the pre-remediation version of the first file with a post-remediation version of the first file.

In Example 15, the subject matter of any one or more of Examples 9-14 optionally include the remedial change comprising closing a port at the portion of the plurality of cloud-based machines.

In Example 16, the subject matter of any one or more of Examples 9-15 optionally include before executing the correction script at the portion of the plurality of cloud-based machines: sending a message indicating the correction script to an administrative user; and receiving from the administrative user and approval of the correction script.

Example 17 is a non-transitory machine-readable medium comprising instructions thereon that, when executed by at least one processor, cause the at least one processor to perform operations comprising: accessing vulnerability data, the vulnerability data describing a software application executed by a portion of a plurality of cloud-based machines and a remedial change to the software application; accessing a pre-remediation version of a first file of the software application from a first cloud-based machine of the portion of the plurality of cloud-based machines; generating a cryptographic hash of the pre-remediation version of the first file; using the vulnerability data, executing a trained computerized model to generate a correction script, the correction script being executable to implement the remedial change to the software application; and executing the correction script at the portion of the plurality of cloud-based machines to implement the remedial change to the software application.

In Example 18, the subject matter of Example 17 optionally includes the operations further comprising: after executing the correction script at the first cloud-based machine, accessing a post-remediation version of the first file from the first cloud-based machine; generating a cryptographic hash of the post-remediation version of the first file; comparing the cryptographic hash of the post-remediation version of the first file to the cryptographic hash of the pre-remediation version of the first file; based on the comparing, determining that the post-remediation version of the first file is different than the pre-remediation version of the first file; and after determining that the post-remediation version of the first file is different than the pre-remediation version of the first file, executing the correction script at a remainder of the portion of the plurality of cloud-based machines.

In Example 19, the subject matter of any one or more of Examples 17-18 optionally include the operations further comprising scanning the plurality of cloud-based machines to identify the portion of the plurality of cloud-based machines executing the software application.

In Example 20, the subject matter of Example 19 optionally includes the scanning comprising comparing the cryptographic hash of the pre-remediation version of the first file to a hash of a current version of the first file at a second cloud-based machine of the plurality of cloud-based machines.

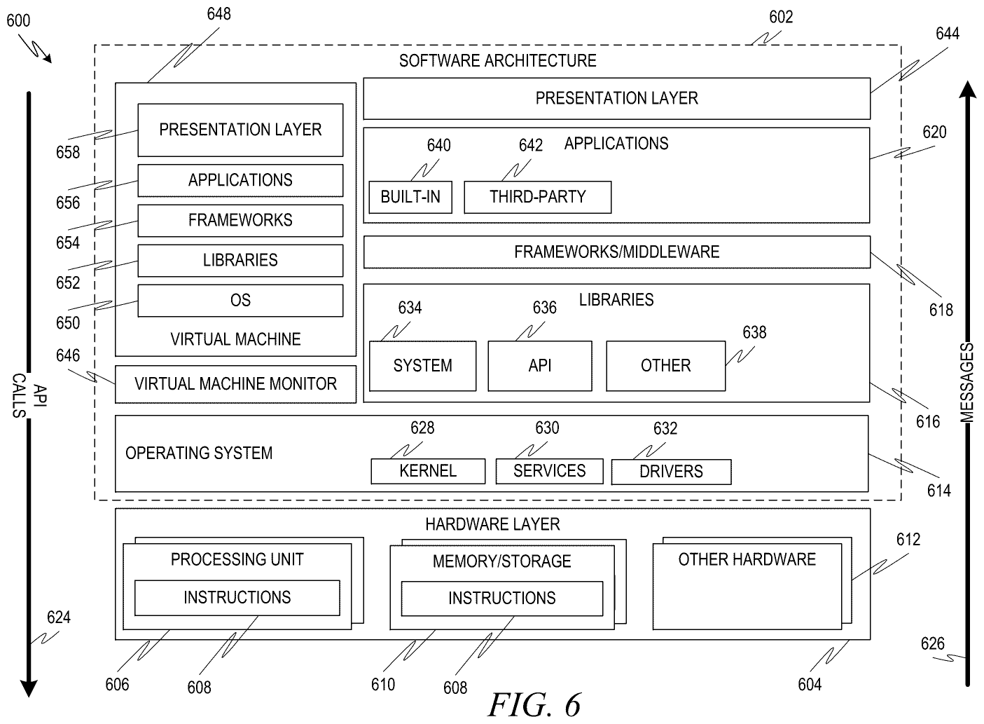

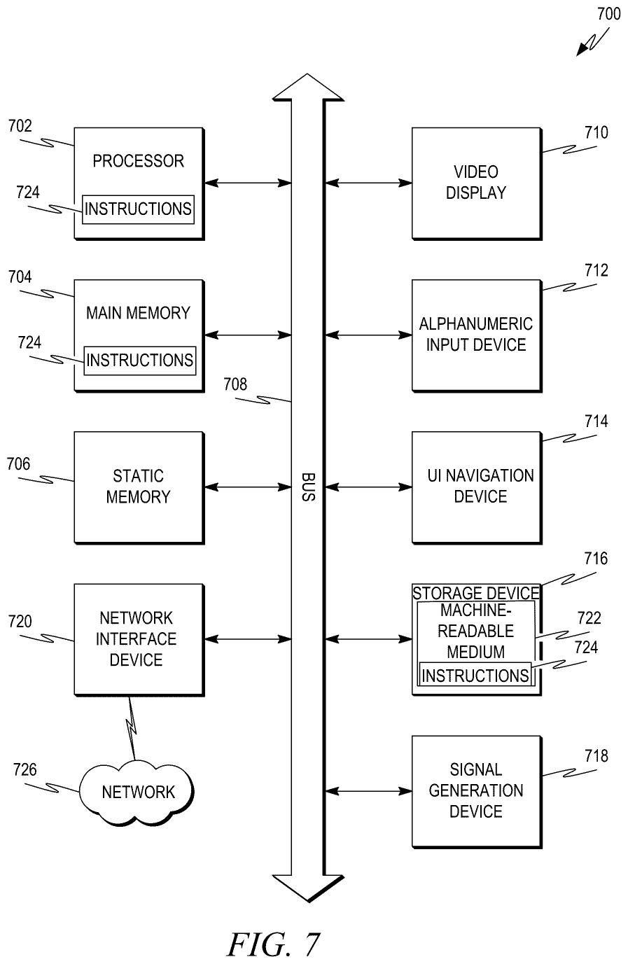

FIG. 6 is a block diagram 600 showing one example of a software architecture 602 for a computing device. The architecture 602 may be used in conjunction with various hardware architectures, for example, as described herein. FIG. 6 is merely a non-limiting example of a software architecture, and many other architectures may be implemented to facilitate the functionality described herein. A representative hardware layer 604 is illustrated and can represent, for example, any of the above referenced computing devices. In some examples, the hardware layer 604 may be implemented according to the architecture of the computer system of FIG. 7.

The representative hardware layer 604 comprises one or more processing units 606 having associated executable instructions 608. Executable instructions 608 represent the executable instructions of the software architecture 602, including implementation of the methods, modules, subsystems, and components, and so forth described herein, and may also include memory and/or storage modules 610, which also have executable instructions 608. Hardware layer 604 may also comprise other hardware as indicated by other hardware 612 which represents any other hardware of the hardware layer 604, such as the other hardware illustrated as part of the architecture 602.

In the example architecture of FIG. 6, the software architecture 602 may be conceptualized as a stack of layers where each layer provides particular functionality. For example, the software architecture 602 may include layers such as an operating system 614, libraries 616, middleware layer 618, applications 620, and presentation layer 644. Operationally, the applications 620 and/or other components within the layers may invoke API calls 624 through the software stack and access a response, returned values, and so forth illustrated as messages 626 in response to the API calls 624. The layers illustrated are representative in nature and not all software architectures have all layers. For example, some mobile or special purpose operating systems may not provide a middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. In some examples, the services 630 include an interrupt service. The interrupt service may detect the receipt of an interrupt and, in response, cause the architecture 602 to pause its current processing and execute an interrupt service routine (ISR) when an interrupt is accessed.

The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system 634 libraries (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The middleware layer 618 (also sometimes referred to as frameworks) may provide a higher-level common infrastructure that may be utilized by the applications 620 and/or other software components/modules. For example, the middleware layer 618 may provide various graphic user interface (GUI) functions, high-level resource management, high-level location services, and so forth. The middleware layer 618 may provide a broad spectrum of other APIs that may be utilized by the applications 620 and/or other software components/modules, some of which may be specific to a particular operating system or platform.

The applications 620 include built-in applications 640 and/or third-party applications 642. Examples of representative built-in applications 640 may include, but are not limited to, a contacts application, a browser application, a book reader application, a location application, a media application, a messaging application, and/or a game application. Third-party applications 642 may include any of the built-in applications 640 as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 642 may invoke the API calls 624 provided by the mobile operating system such as operating system 614 to facilitate functionality described herein.

The applications 620 may utilize built-in operating system functions (e.g., kernel 628, services 630 and/or drivers 632), libraries (e.g., system 634, API libraries 636, and other libraries 638), and middleware layer 618 to create user interfaces to interact with users of the system. Alternatively, or additionally, in some systems interactions with a user may occur through a presentation layer, such as presentation layer 644. In these systems, the application/module “logic” can be separated from the aspects of the application/module that interact with a user.

Some software architectures utilize virtual machines. In the example of FIG. 6, this is illustrated by virtual machine 648. A virtual machine creates a software environment where applications/modules can execute as if they were executing on a hardware computing device. A virtual machine is hosted by a host operating system (operating system 614) and typically, although not always, has a virtual machine monitor 646, which manages the operation of the virtual machine 648 as well as the interface with the host operating system (i.e., operating system 614). A software architecture executes within the virtual machine 648 such as an operating system 650, libraries 652, frameworks/middleware 654, applications 656 and/or presentation layer 658.

These layers of software architecture executing within the virtual machine 648 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 7 is a block diagram of a machine in the example form of a computer system 700 within which instructions 724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation (or cursor control) device 714 (e.g., a mouse), a disk drive unit 716, a signal generation device 718 (e.g., a speaker), and a network interface device 720.

### Machine-Readable Medium

The disk drive unit 716 includes a machine-readable medium 722 that may have stored thereon one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable media 722.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present disclosure, or that is capable of storing, encoding, or carrying data structures utilized by or associated with such instructions 724. The term “machine-readable medium” shall accordingly be taken to include, but not be limited to, solid-state memories, and optical and magnetic media. Specific examples of machine-readable media 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 724 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for maintaining a plurality of cloud-based machines, the system comprising:
at least one processor programmed to perform operations comprising:
accessing vulnerability data, the vulnerability data describing a software application executed by a portion of the plurality of cloud-based machines and a remedial change to the software application;
accessing a pre-remediation version of a first file of the software application from a first cloud-based machine of the portion of the plurality of cloud-based machines;
generating a cryptographic hash of the pre-remediation version of the first file;
using the vulnerability data, executing a trained computerized model to generate a correction script, the correction script being executable to implement the remedial change to the software application; and
executing the correction script at the portion of the plurality of cloud-based machines to implement the remedial change to the software application.

2. The system of claim 1, the operations further comprising:
after executing the correction script at the first cloud-based machine, accessing a post-remediation version of the first file from the first cloud-based machine;
generating a cryptographic hash of the post-remediation version of the first file;
comparing the cryptographic hash of the post-remediation version of the first file to the cryptographic hash of the pre-remediation version of the first file;
based on the comparing, determining that the post-remediation version of the first file is different than the pre-remediation version of the first file; and
after determining that the post-remediation version of the first file is different than the pre-remediation version of the first file, executing the correction script at a remainder of the portion of the plurality of cloud-based machines.

3. The system of claim 1, the operations further comprising scanning the plurality of cloud-based machines to identify the portion of the plurality of cloud-based machines executing the software application.

4. The system of claim 3, the scanning comprising comparing the cryptographic hash of the pre-remediation version of the first file to a hash of a current version of the first file at a second cloud-based machine of the plurality of cloud-based machines.

5. The system of claim 1, the operations further comprising:
accessing second vulnerability data, the second vulnerability data describing a second software application executed by a second portion of the plurality of cloud-based machines and a remedial change to the second software application;
determining that an existing correction script is executable to implement the remedial change to the second software application; and
executing the existing correction script at the second portion of the plurality of cloud-based machines to implement the remedial change to the second software application.

6. The system of claim 1, the remedial change comprising replacing the pre-remediation version of the first file with a post-remediation version of the first file.

7. The system of claim 1, the remedial change comprising closing a port at the portion of the plurality of cloud-based machines.

8. The system of claim 1, the operations further comprising, before executing the correction script at the portion of the plurality of cloud-based machines:
sending a message indicating the correction script to an administrative user; and
receiving from the administrative user and approval of the correction script.

9. A method for maintaining a plurality of cloud-based machines, the method comprising:
accessing vulnerability data, the vulnerability data describing a software application executed by a portion of the plurality of cloud-based machines and a remedial change to the software application;
accessing a pre-remediation version of a first file of the software application from a first cloud-based machine of the portion of the plurality of cloud-based machines;
generating a cryptographic hash of the pre-remediation version of the first file;
using the vulnerability data, executing a trained computerized model to generate a correction script, the correction script being executable to implement the remedial change to the software application; and
executing the correction script at the portion of the plurality of cloud-based machines to implement the remedial change to the software application.

10. The method of claim 9, further comprising:
after executing the correction script at the first cloud-based machine, accessing a post-remediation version of the first file from the first cloud-based machine;
generating a cryptographic hash of the post-remediation version of the first file;
comparing the cryptographic hash of the post-remediation version of the first file to the cryptographic hash of the pre-remediation version of the first file;
based on the comparing, determining that the post-remediation version of the first file is different than the pre-remediation version of the first file; and
after determining that the post-remediation version of the first file is different than the pre-remediation version of the first file, executing the correction script at a remainder of the portion of the plurality of cloud-based machines.

11. The method of claim 9, further comprising scanning the plurality of cloud-based machines to identify the portion of the plurality of cloud-based machines executing the software application.

12. The method of claim 11, the scanning comprising comparing the cryptographic hash of the pre-remediation version of the first file to a hash of a current version of the first file at a second cloud-based machine of the plurality of cloud-based machines.

13. The method of claim 9, further comprising:
accessing second vulnerability data, the second vulnerability data describing a second software application executed by a second portion of the plurality of cloud-based machines and a remedial change to the second software application;
determining that an existing correction script is executable to implement the remedial change to the second software application; and
executing the existing correction script at the second portion of the plurality of cloud-based machines to implement the remedial change to the second software application.

14. The method of claim 9, the remedial change comprising replacing the pre-remediation version of the first file with a post-remediation version of the first file.

15. The method of claim 9, the remedial change comprising closing a port at the portion of the plurality of cloud-based machines.

16. The method of claim 9, further comprising, before executing the correction script at the portion of the plurality of cloud-based machines:
sending a message indicating the correction script to an administrative user; and
receiving from the administrative user and approval of the correction script.

17. A non-transitory machine-readable medium comprising instructions thereon that, when executed by at least one processor, cause the at least one processor to perform operations comprising:
accessing vulnerability data, the vulnerability data describing a software application executed by a portion of a plurality of cloud-based machines and a remedial change to the software application;
accessing a pre-remediation version of a first file of the software application from a first cloud-based machine of the portion of the plurality of cloud-based machines;
generating a cryptographic hash of the pre-remediation version of the first file;
using the vulnerability data, executing a trained computerized model to generate a correction script, the correction script being executable to implement the remedial change to the software application; and
executing the correction script at the portion of the plurality of cloud-based machines to implement the remedial change to the software application.

18. The non-transitory machine-readable medium of claim 17, the operations further comprising:
after executing the correction script at the first cloud-based machine, accessing a post-remediation version of the first file from the first cloud-based machine;
generating a cryptographic hash of the post-remediation version of the first file;
comparing the cryptographic hash of the post-remediation version of the first file to the cryptographic hash of the pre-remediation version of the first file;
based on the comparing, determining that the post-remediation version of the first file is different than the pre-remediation version of the first file; and
after determining that the post-remediation version of the first file is different than the pre-remediation version of the first file, executing the correction script at a remainder of the portion of the plurality of cloud-based machines.

19. The non-transitory machine-readable medium of claim 17, the operations further comprising scanning the plurality of cloud-based machines to identify the portion of the plurality of cloud-based machines executing the software application.

20. The non-transitory machine-readable medium of claim 19, the scanning comprising comparing the cryptographic hash of the pre-remediation version of the first file to a hash of a current version of the first file at a second cloud-based machine of the plurality of cloud-based machines.
